(19) United States
(12) Patent Application Publication
(10) Pub. No.: US 2019/0286088 A1
(43) Pub. Date: Sep. 19, 2019

(54) COMMAND AND REPORTING SYSTEM FOR AUTOMATION

(71) Applicant: SIEMENS AKTIENGESELLSCHAFT, München (DE)

(72) Inventors: Frantisek Mandat, Trutnov (CZ); Helmut Staufer, Weiherhammer (DE); Zdenek Krejsa, Pribram (CZ)

(21) Appl. No.: 16/465,144

(22) PCT Filed: Nov. 8, 2017
(86) PCT No.: PCT/EP2017/078648

§ 371 Date: May 29, 2019

(30) Foreign Application Priority Data
Nov. 30, 2016 (DE) 10 2016 223 795.0

(51) Int. Cl. G05B 19/042; G06F 13/20

(52) U.S. Cl. CPC G05B 19/0425; G05B 2219/24024; G05B 2219/21063; G06F 13/20

(57) ABSTRACT

The invention relates to a main module (10) for a command and reporting system (50), which main module comprises a control unit (16) and a device interface (18) for coupling to at least two command and reporting devices (12, 12.1, 12.2, 12.3, 12.n) in a line topology. The main module (10) also has a bus interface (13) for connecting to a superordinate control unit (11), wherein the control unit (16), by means of the device interface (18), is designed to control at least two command and reporting devices (12, 12.1, 12.2, 12.3, 12.n) separately by means of a command signal (20). According to the invention, the command signal (20) is designed for device-address-free delivery at the respective command and reporting device (12, 12.1, 12.2, 12.3, 12.n) and has a target cell (22) and an incrementable counting cell (24) for this purpose. The invention further relates to a method (100) by means of which the device-address-free delivery is implemented. The invention further relates to a computer program product (80) suitable therefor, to a command and reporting system (50) in which the invention is implemented, and to an automation system (60) equipped with a corresponding command and reporting system (50).

This application is the National Stage of International Application No. PCT/EP2017/078648, filed Nov. 8, 2017, which claims the benefit of German Patent Application No. 10 2016 223 795.0, filed Nov. 30, 2016. The entire contents of these documents are hereby incorporated herein by reference.

### BACKGROUND

The present embodiments relate to a command and reporting system for automation, a main module for such a command and reporting system, a method for sending data from a main module to command and reporting devices in a corresponding command and reporting system, and an automation system having a corresponding command and reporting system.

Automation systems today have an increasing range of functions and thus an increasing complexity. Accordingly, the number of variables and states that are to be displayed to a user increases. A plurality of variables is available to the user for manual operation or for setting an automation system, for which suitable input devices are to be provided. As the range of functions of an automation system increases, so does the difficulty of establishing such automation systems without errors. There is a need for a system for command and reporting devices that show the user information and receive user commands, which may be set up and established in an easy, quick, and failsafe manner.

From the publication WO 2009/006916 A1, a system for controlling bus-networked devices via an open field bus that has a gateway that is connected to a multiplicity of bus subscribers is known. The connection takes place via a LIN bus, in which a code number is assigned to each bus subscriber.

A disadvantage of the solutions from the prior art is, inter alia, that the administration of the code numbers requires computing capacities. Furthermore, the known systems have only a relatively narrow range of applications.

### SUMMARY AND DESCRIPTION

The scope of the present invention is defined solely by the appended claims and is not affected to any degree by the statements within this summary.

There is a need for a simple, failsafe, cost-effective command and reporting device system that offers a high degree of versatility.

The present embodiments may obviate one or more of the drawbacks or limitations in the related art. For example, a main module forms the technical basis for a corresponding command and reporting system for automation. The main module has a control unit (e.g., a controller) that is configured to receive, evaluate, and process data and commands via connected inputs. The control unit is also configured to output data and commands via connected outputs after such processing. The inputs associated with the control unit also include a device interface that is set up to connect the main module to a plurality of command and reporting devices. A first command and reporting device is directly connected to the device interface for this purpose. A second command and reporting device is connected to the first command and reporting device so that there is an indirect connection to the control unit of the main module. The second command and reporting device may likewise be connected to further command and reporting devices. As a result, a line topology is realized. The control unit is also connected to a bus interface, by which a connection to a higher-level control unit (e.g., a programmable logic controller (PLC)) may be produced. The main module may also be configured to fulfill the functions of a command and reporting device.

The control unit, using the device interface, is configured to control at least two command and reporting devices separately (e.g., individually). Control takes place using a command signal that is transmitted by the control unit to at least one of the at least two command and reporting devices using the device interface. According to one or more of the present embodiments, the command signal has a plurality of cells that are configured to transport information individually or in combination with adjacent cells. The function of a cell within a command signal is defined by a format of the command signal. According to one or more of the present embodiments, the command signal has a target cell that may be described by the control unit with a value that serves as a target specification for the command signal. The value in the target cell defines the command and reporting system for which the command signal is intended (e.g., via a chain position in the line topology). This essentially corresponds to counting the command and reporting devices from the main module. The command signal also includes a counting cell that is filled with an initial value when the command signal is sent from the device interface. The counting cell is configured such that the value stored therein may be overwritten by a command and reporting device. The command and reporting devices are configured to read out and compare the value of the target cell and the counting cell on receiving the command signal. If the values in the target cell and the counting cell differ from one another, the command and reporting devices are configured to increment (e.g., to increase by one increment) the value of the target cell. As a result, a command signal originating from the main module is forwarded from one command and reporting device to the next until the command signal is identified and received by the intended recipient. Such a target cell is provided by the control unit in the main module by suitable formatting of the command signal. As a result, independent addressing of the command and reporting devices is unnecessary, so that a device-address-free delivery is realized.

The main module according to one or more of the present embodiments thus allows a simple construction of a command and reporting system in which complex address space management is dispensed with for the command and reporting devices. The line topology is also easily expandable later with additional command and reporting devices. Not only is the workload reduced when setting up an automation system, but the probability of errors is also reduced when setting up the automation system. The demand for computing power for the operation of the command and reporting devices is also reduced. Accordingly, the main module according to one or more of the present embodiments may be produced with cost-efficient hardware. As an alternative or in addition, the reduced demand in terms of computing power may be employed to make use of the freed-up computing capacity for operating further connections. Due to the fact that the command and reporting devices may be configured to be device-address-free of the main module according to one or more of the present embodiments, there is no need for failsafe memories for device addresses. Likewise, complex reconfiguration methods that are required, for example, after a reset or replacement of a known command and reporting device, are unnecessary. Equally, removal or expansion of an associated command and reporting system does not require any complicated re-addressing of the command and reporting devices or main module. Command and reporting devices may also be constructed more simply by the main module according to one or more of the present embodiments and produced more cost-effectively.

In one embodiment, the device interface is configured as a serial interface. A serial interface has a high degree of robustness and allows easy communication between the command and reporting devices and the main module. As an alternative or in addition, the device interface is configured to also transfer data from at least one command and reporting device to the main module.

The main module according to one or more of the present embodiments also includes at least one digital input. In addition, or as an alternative, the main module according to one or more of the present embodiments has at least one analog input. Additional analog or digital inputs permit additional input devices that have increased complexity to be connected to the main module. For example, by connecting four digital inputs, a four-way switch or joystick may be coupled to the main module as an input device or an analog input device. For example, a potentiometer may be connected to the analog input. As a result of the simplicity of the control of the command and reporting devices, the main module according to one or more of the present embodiments has free computing capacity that may be used for the operation of the additional more complex input devices. As a result, such input devices may be integrated into an existing automation system at a low hierarchical level. This obviates the need for a complex adaptation of the configuration at higher hierarchical levels of the automation system (e.g., at the level of the PLC). Overall, the versatility of the main module according to one or more of the present embodiments is increased further.

The main module according to one or more of the present embodiments may also be provided with at least one digital output. As an alternative or in addition, the main module may also be equipped with at least one analog output. Thus, additional output devices (e.g., a multi-stage reporting column) may be connected to a corresponding main module. This also further increases the versatility of the main module, and thus of a command and reporting system.

The main module according to one or more of the present embodiments may have a safety signal input, via which a safety-oriented device may be connected. A safety signal may be a signal input that is suitable and qualified for safety-oriented applications (e.g., an emergency stop). The control unit in the main module according to one or more of the present embodiments is suitable for receiving and evaluating the signals from the safety signal input. The control unit is configured to process the signals from the safety signal input separately from the further signals, for example, of a communication via the device interface, the digital outputs, or the analog outputs and thus provide a high level of safety. This is achieved by a modular design of the control unit.

In a further embodiment, the command signal is configured to transfer at least one parameter separately to at least one of the command and reporting devices. The command signal has at least one parameter cell in which such a parameter that determines the behavior of the command and reporting device may be stored. If the command and reporting device is configured, for example, as an illuminated element or illuminated button, the luminosity or the flashing frequency may be parameters, for example, that are transported via the command signal. If the command and reporting device includes an LED, for example, the color of an illuminated display of the command and reporting device may also be set. All variables that are suitable for the device-specific setting of a command and signaling device may be selected as parameters. Such a parameterization is transmitted by the main module according to one or more of the present embodiments to a relatively low hierarchical level of the automation system to be established. As a result, higher-level levels (e.g., the higher-level control unit such as a PLC) are kept free of these tasks, which reduces the complexity when setting up the higher-level control unit and thus prevents the occurrence of errors. At the same time, a high degree of individualization is available when setting up the automation system with the main module according to one or more of the present embodiments.

The control unit in the main module according to one or more of the present embodiments may be connected to a connection for an exchangeable storage module. The storage module may, for example, be configured as a USB memory or as an EEPROM memory. The connection between the connection for the exchangeable storage module and the control unit is configured to allow transmission of parameters from the storage module to the control unit that is failsafe. An error may be a change of a bit in the transmitted parameters. As a result, the device of the automation system that is equipped with the main module according to one or more of the present embodiments is further simplified. In the event of an exchange of the safety-oriented device, the configuration and/or parameterization may be read immediately from the exchangeable storage module again. As a result, complex reconfigurations or new parameterizations are avoided and downtimes of the automation system are reduced. This increases the economic viability of the automation system.

As another example, a method for sending a command signal is provided. The command signal is generated by a control unit of a main module that is connected to at least two command and reporting devices. The main module is directly connected to a first command and reporting device via a device interface. The first command and reporting device is in turn connected to a second command and reporting device. A line topology is thus formed. The command signal is to be sent to an individual target device in the method according to one or more of the present embodiments. The individual target device is a selected command and reporting device. In a first method act, the command signal is provided by the control unit of the main module for transmission. For this purpose, the command signal is generated by the control unit and/or generated by a higher-level control unit and sent to the main module. A command signal that is generated by the higher-level control unit may also be modified by the main module. The command signal includes a target cell in which a value is stored, by which a target device may be determined. The value in the target cell is invariable during the transmission. The value in the target cell corresponds to a chain position of the target device in the line topology (e.g., substantially corresponds to the result of counting the command and reporting devices starting from the main module). The command signal also includes a counter cell that may be changed by the command and reporting devices in the line topology.

In a further method act, a value corresponding to the desired target device is set for the target cell. The target device is selected, for example, by a user input or by information or commands from a higher-level control unit (e.g., a PLC). An initial value is also written into the counter cell. The initial value is selected such that the initial value corresponds to the chain position of the command and reporting device, which is connected directly to the main module via the device interface.

During a further method act, the command signal is sent to the command and reporting device directly connected to the main module. In a subsequent method act, the command signal is received and the command and reporting device checks whether the values in the target cell match the counter cell. If the values of the target cell and the counter cell differ from one another, the counter value is incremented (e.g., increased by a fixed increment). The increment is, for example, a natural number (e.g., one). Then, the command signal is forwarded to an adjacent command and reporting device. Forwarding takes place along the line topology in a direction that leads away from the main module.

If, during checking by the command and reporting device it is detected that the value of the counting cell corresponds to the value of the target cell, it is thus detected that the command and reporting device that is performing the checking act is itself the target device. In this case, the command signal is received by the target device and processed (e.g., converted) as a command.

The method makes it possible to quickly and reliably deliver a command signal specifically to a single command and reporting device without the need for addresses to be stored in the command and reporting devices for this purpose. As a result, the command and reporting devices may be configured in a simple and cost-efficient manner. The method according to one or more of the present embodiments has low requirements in terms of computing power. The computing power thus saved in the main module may therefore be used for the implementation of additional functions. As a result, the versatility of an automation system that uses the method according to one or more of the present embodiments is increased overall.

As yet another example, a computer program product that is executable in a control unit of a main module is provided. The computer program product is stored in the main module in a correspondingly designed memory. The main module is connected to a plurality of command and reporting devices in a line topology. According to one or more of the present embodiments, the computer program product is configured to execute at least one of the methods described above for sending a command signal from the main module to an individual command and reporting device. Alternatively, the computer program product may be stored in the form of fixed wiring, for example, in an ASIC.

As another example, a command and reporting system according to one or more of the present embodiments having a plurality of command and reporting devices that are connected to each other in a line topology is provided. The command and reporting system also includes a main module that is coupled to the plurality of command and reporting devices at one end of the line topology. In this case, the main module is configured according to one of the embodiments described above.

As yet another example, an automation system that has a higher-level control unit is provided.

The higher-level control unit is, for example, configured as a PLC. The higher-level control unit is coupled to a command and reporting system including a plurality of command and reporting devices that are connected to a main module. In this case, the command and reporting system is configured according to one of the embodiments outlined above.

### BRIEF DESCRIPTION OF THE DRAWINGS

The features of the individual embodiments may be combined with one another. In the figures, shown in detail:

FIG. 1 shows a diagrammatic view of a command and reporting system according to an embodiment;

FIG. 2 shows a diagrammatic structure of a command signal according to an embodiment;

FIG. 3 shows a diagrammatic view of the sequence of a method according to an embodiment in a command and reporting system; and

FIG. 4 shows a flowchart of an embodiment of the method.

### DETAILED DESCRIPTION

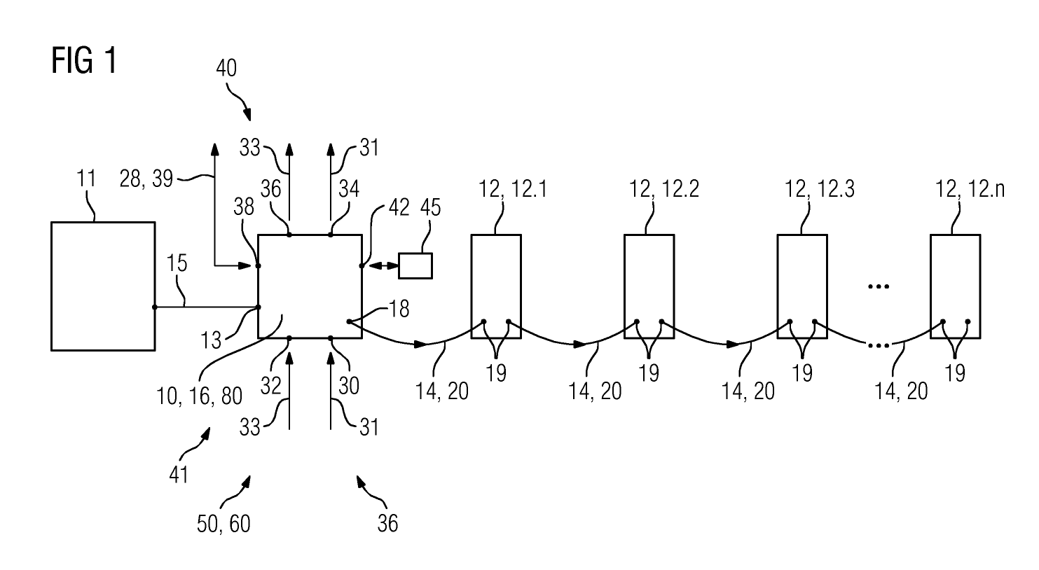

FIG. 1 is a diagrammatic view of a command and reporting system 50 according to an embodiment. The command and reporting system 50 includes a main module 10 having a control unit 16. The control unit 16, and thus the main module 10, is connected to a plurality of command and reporting devices 12, 12.1, 12.2, 12.3, 12.n that form a line topology. In this case, a first command and reporting device 12.1 has a line connection 19 that is coupled to a device interface 18 of the main module 10 via a device line 14. Via a further line connection 19, the first command and reporting device 12.1 is connected to an adjacent second reporting device 12.2 via line connections 19 and a device line 14. The linkage thus realized is continued analogously to the last command and reporting device 12.n. The control unit 16 of the main module 10 is configured to generate a command signal 20 that is output via the device interface 18. The command signal 20 may be transported via the device lines 14 to the last command and reporting device 12.n in the line topology. The main module 10 also has a bus connection 13 to which a bus line 15 is connected. The bus line 15 establishes a bidirectionally communicative connection between the main module 10 and a higher-level control unit 11. In FIG. 1, the higher-level control unit 11 is configured as a programmable logic controller (PLC). As a result of the bus line 15 and the bus connection 13, the main module 10 is suitable for receiving commands from the higher-level control unit 11 and/or sending data to the higher-level control unit from the command and reporting devices 12, 12.1, 12.2, 12.3, 12.n.

The main module 10 also has a safety signal input 38 that is configured to receive safety-related signals 39 from at least one safety-oriented device 40 not shown in greater detail. A safety-oriented device may be a device such as an emergency stop device. The safety signal input 38 is also configured to transmit parameters 28 to at least one safety-oriented device. The main module 10 is also provided with a digital input 30 via which digital additional devices 36 not shown in more detail may be connected. The digital additional devices 36 transmit digital input signals 31 to the main module 10. In the same way, the main module 10 has an analog connection 32 that is configured to receive analog input signals 33 originating from analog additional devices 41 not shown in more detail. Likewise, the main module 10 has a digital output 34 and an analog output 36. By way of the digital output 34 and the analog output 36, digital and/or analog output signals 31, 33 are respectively sent to at least one digital and/or analog additional device 36, 41 not shown in more detail.

The main module 10 also has a memory connection 42 that is configured to detachably receive an exchangeable storage module 45. The storage module 45 is configured to store configuration and parameterization data for the main module 10 and the devices 12, 36, 40, 41 coupled thereto and to transfer the configuration and parameterization data to the control unit 16. Between the memory connection 42 and the control unit 16, there is a communication link that is secure against data loss and non-intended data changes. Non-intended data changes may be, for example, the “dropping” of a bit (e.g., a corresponding value reversal) or an unauthorized write access. The command and reporting system 50 according to FIG. 1 is part of an automation system 60 not shown in more detail.

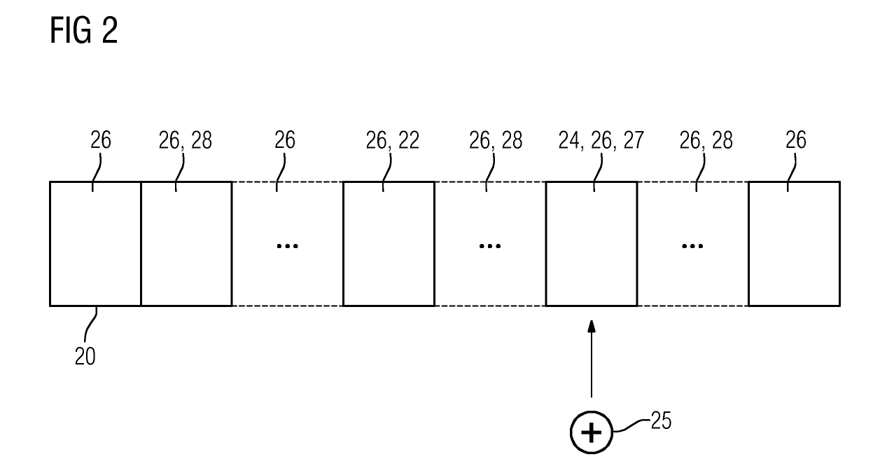

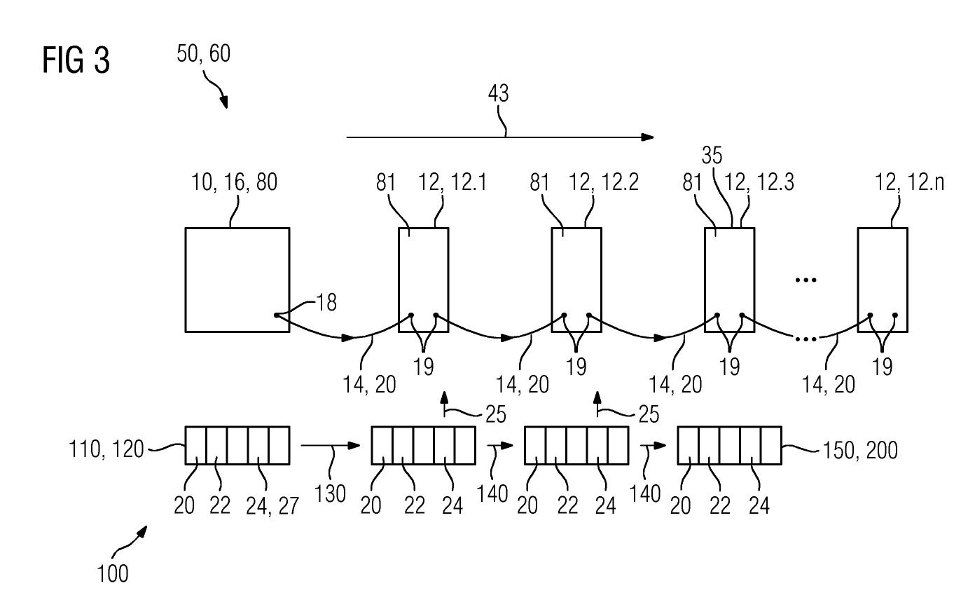

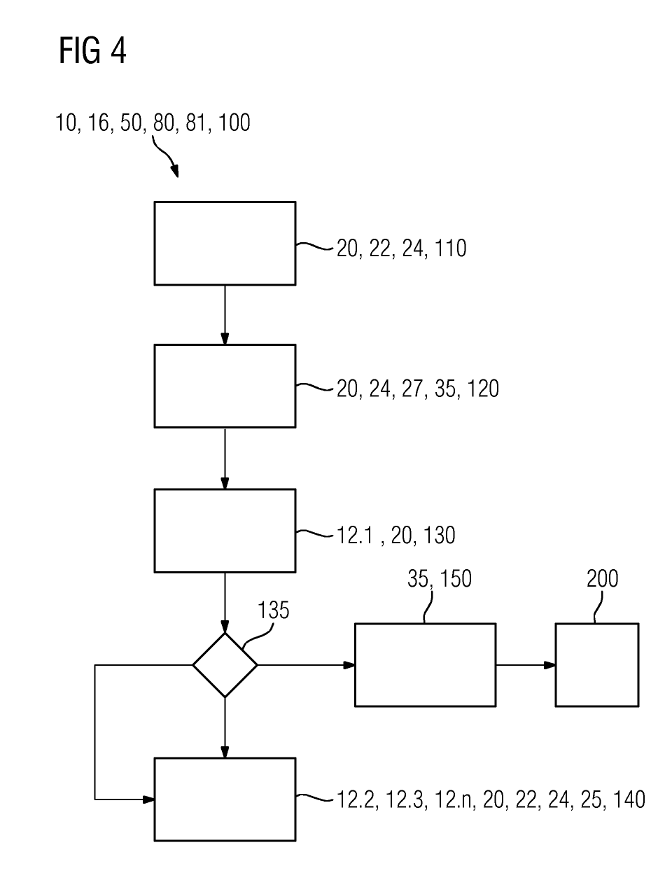

FIG. 2 shows diagrammatically the structure of a command signal 20 that is generated and sent by the control unit 16 of the main module 10 from FIG. 1. The command signal 20 includes a plurality of data lines 26 in which data may be written by the control unit 16 and/or a command and reporting device 12. The sequence of the data lines 26 defines the format of the command signal 20. Certain data lines 26 are used to transport parameters 28 to a designated command and reporting device 12. One of the data lines 26 is configured as a target cell 22. The value in the target cell 22 is determined by the control unit 16 of the main module 10 when generating the respective command signal 20. The value in the target cell 22 is invariable during the method 100 according to one or more of the present embodiments, which is explained in more detail by way of example in FIG. 3 and FIG. 4. The value in the target cell 22 is configured such that the value in the target cell 22 corresponds to a chain position of a target device 35 in a line topology. The target device 35 represents the command and reporting device 12 to which the command signal 20 is to be supplied. The command signal 20 also includes a counting cell 24 that is described with an initial value 27 when generating the command signal 20. The value in the counting cell 26 may be changed during the method 100 according to one or more of the present embodiments by adding an increment 25. The counting cell 26 is incremented by a command and reporting device 12.

An embodiment of the method 100 for sending a command signal 20 from a main module 10 to a particular command and reporting device 12, 12.1, 12.2, 12.3, 12.n is shown in FIG. 3 by way of example. The structure from FIG. 3 essentially corresponds to that from FIG. 1. The same reference characters have the same technical meaning. The command and reporting device 12.3 to which the command signal 20 is to be supplied forms the target device 35. The command and reporting devices 12, 12.1, 12.2, 12.3, 12.n and the main module 10 together act as a command and reporting system 50 that is associated with an automation system 60. In the method 100, in a first method act 110, a command signal 20 is provided by the control unit 16 from the main module 10. The command signal 20 is to be supplied to the target device 35. The command signal 20 may be generated by the main module 10. In other words, the command signal 20 may be generated by the control unit 16 of the main module 10, and/or the command signal 20 is sent by a higher-level control unit 11 not shown in more detail to the main module 10. The chain position of the target device 35 is stored in a target cell 22 of the command signal 20 in a second method act 120. The command signal 20 generated in the first act 110 also includes a counting cell 24 into which an initial value 27 is written by the control unit 16 in the second method act 120.

In a subsequent third method act 130, the command signal 20 is output by a device interface 18. Via a device line 14, the command signal 20 reaches a first command and reporting device 12.1 that is directly connected to the main module 10. The device line 14 is connected to a line connection 19. The command signal 20 is evaluated in the first command and reporting device 12.1. It is detected whether the value in the target cell 22 corresponds to the value in the counting cell 24. In other words, it is detected whether the first command and reporting device 12.1 is the target device 35. In the method sequence according to FIG. 3, this is not the case. In a fourth method act 140, the value in the counting cell 24 is increased by one increment 25. In the fourth method act 140, the command signal 20 is forwarded via the corresponding device line 14 along a transport direction 43 to the second command and reporting device 12.2. In the second command and reporting device 12.2, it is also checked whether the value in the counting cell 24 corresponds to the value in the target cell 22. The fourth method act 140 with the increase of the value in the counting cell 24 by the increment 25 is repeated, and the command signal 20 is sent further along the transport direction 43.

The third command and reporting device 12.3 detects that this is the target device 25. This is detected by identifying that the value in the counting cell 24 corresponds to the value in the target cell 22. As a result, a device-specific delivery of the command signal 20 to the target device 35 is achieved. In this case, the command and reporting devices 12, 12.1, 12.2, 12.3, 12.n are free of addresses that are stored therein. As a result, an address-free delivery is provided on the side of the command and reporting devices 12, 12.1, 12.2, 12.3, 12.n, which leads to a simplification and reduction of the requirements in terms of computing power. In the third command and reporting device 12.3, which is used as a target device 35, a fifth method act 150 follows, in which the command signal 20 is received and converted. The method 100 according to one or more of the present embodiments is thus completed, and an end state 200 occurs. In the control unit 16 of the main module 10, a computer program product 80 is stored in an executable manner and is configured to implement the corresponding method 100 in the main module 10. The command and reporting devices 12 are equipped with a subprogram 81 that converts the method acts 140, 150 into the individual command and reporting devices 12, 12.1, 12.2, 12.3, 12.n and thus interacts with the computer program product 80 in the main module 10.

The method 100 from FIG. 3 is exemplary. The description based on FIG. 3 applies without loss of generality to any other command and reporting device 12, 12.1, 12.2, 12.n as a target device 35 in a line topology with n command and reporting devices 12.

FIG. 4 diagrammatically shows a sequence of an embodiment of the method 100, which is converted by a computer program product 80 into a control unit 16 in a main module 10 of a command and reporting system 50. In a first method act 110, a command signal 20 including a target cell 22 and a counting cell 24 is generated. The command signal 20 is generated by the control unit 16 of the main module 10.

In a second method act 120, the value of the counting cell 22 is described by the control unit 16 with an initial value 27. In the second method act 120, the target device 35 is determined, and the target cell 22 is described accordingly. In a subsequent third method act 130, the command signal 20 is sent from the main module 10 to the directly connected first command and reporting device 12.1. A branch 135 follows in which it is checked whether the first command and reporting device 12.1 that receives the command signal 20 immediately after the third step 130 is the target device 35. This is done by a comparison between the values in the target cell 22 and the counting cell 24. If the value of the counting cell 24 differs from the value in the target cell 22, the fourth method act 140 follows. In the fourth method act 140, the value of the counting cell 24 is increased by one increment 25. The command signal 20 is forwarded to an adjacent command and reporting device 12.2 with a constant value in the target cell 22 and the changed counting cell 24. This sequence (i.e., the execution of the fourth act 140 and the decision at the branch 135) is repeated as required, and the command signal 20 is forwarded to further command and reporting devices 12.3, 12.n. The counting cell 24 is then incremented.

If it is detected in the branch 135 that the value in the counting cell 24 corresponds to the value in the target cell 22, the fifth method act 150 follows. The command signal 20 is received therein and processed by the target device 35 (e.g., one of the command and reporting devices 12) in a line topology. The final state 200 then occurs, in which the command and reporting system 50 is available for a new execution of the method 100.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A main module for a command and reporting system, the main module comprising:
a controller;
a device interface coupleable to at least two command and reporting devices in a line topology; and
a bus interface connectable to a higher-level controller,
wherein the controller is configured, with the device interface, to control two or more of the at least two command and reporting devices separately by a command signal, and
wherein the command signal has a target cell and an incrementable counting cell for device-address-free delivery at the respective command and reporting device.

2. The main module of claim 1, wherein the device interface is configured as a serial interface, is configured to transmit data from at least one command and reporting device of the at least two command and reporting devices to the main module, or a combination thereof.

3. The main module of claim 1, further comprising at least one digital input configurable by a user, at least one analog input configurable by the user, or a combination thereof.

4. The main module of claim 1, further comprising at least one digital output configurable by the user, at least one analog output configurable by the user, or a combination thereof.

5. The main module of claim 1, further comprising at least one safety signal input for a safety-oriented device.

6. The main module of claim 1, wherein the command signal is configured to transport a parameter separately to at least one of the at least two command and reporting devices.

7. The main module of claim 5, wherein the controller has a connection for an exchangeable storage module configured to transmit at least one parameter for the safety-oriented device.

8. A method for sending a command signal from a main module to an individual target device from a plurality of command and reporting devices that are connected to the main module in a line topology, the method comprising:
generating a command signal, the command signal comprising a target cell and a counter cell;
setting a value for the target cell corresponding to the individual target device and setting an initial value for the counter cell;
transmitting the command signal to a command and reporting device of the plurality of command and reporting devices, the command and reporting device being directly connected to the main module;
forwarding the command signal to a further command and reporting device of the plurality of command and reporting devices and increasing the value of the counter cell by one increment when, while receiving the command signal, the value of the counter cell differs from the value of the target cell; and
receiving and processing the command signal by the target device when, while receiving the command signal, the value of the counter cell corresponds to the value of the target cell.

9. In a non-transitory computer-readable storage medium that stores instructions executable by a controller of a main module that is connected to a plurality of command and reporting devices in a line topology to send a command signal from the main module to an individual target device from the plurality of command and reporting devices that are connected to the main module in the line topology, the instructions comprising:
generating a command signal, the command signal comprising a target cell and a counter cell;
setting a value for the target cell corresponding to the individual target device and setting an initial value for the counter cell;
transmitting the command signal to a command and reporting device of the plurality of command and reporting devices, the command and reporting device being directly connected to the main module;
forwarding the command signal to a further command and reporting device of the plurality of command and reporting devices and increasing the value of the counter cell by one increment when, while receiving the command signal, the value of the counter cell differs from the value of the target cell; and
receiving and processing the command signal by the target device when, while receiving the command signal, the value of the counter cell corresponds to the value of the target cell.

10. A command and reporting system comprising:
a plurality of command and reporting devices that are connected to each other in a line topology; and
a main module that is coupled to one command and reporting device of the plurality of command and reporting devices by a device interface, the main module comprising:
a controller;
the device interface, which is coupleable to at least two command and reporting devices of the plurality of command and reporting devices in the line topology; and
a bus interface connectable to a higher-level controller,
wherein the controller is configured, with the device interface, to control two or more of the at least two command and reporting devices separately by command signal, and
wherein the command signal has a target cell and an incrementable counting cell for device-address-free delivery at the respective command and reporting device.

11. An automation system comprising:
a higher-level controller that is coupled to a command and reporting system, the command and reporting system comprising:
a plurality of command and reporting devices that are connected to each other in a line topology; and
a main module that is coupled to one command and reporting device of the plurality of command and reporting devices by a device interface, the main module comprising:
a controller;
the device interface, which is coupleable to at least two command and reporting devices of the plurality of command and reporting devices in the line topology; and
a bus interface connectable to a higher-level controller,
wherein the controller is configured, with the device interface, to control two or more of the at least two command and reporting devices separately by command signal, and
wherein the command signal has a target cell and an incrementable counting cell for device-address-free delivery at the respective command and reporting device.

12. The command and reporting system of claim 10, wherein the device interface is configured as a serial interface, is configured to transmit data from at least one command and reporting device of the at least two command and reporting devices to the main module, or a combination thereof.

13. The command and reporting system of claim 10, wherein the main module further comprises at least one digital input configurable by a user, at least one analog input configurable by the user, or a combination thereof.

14. The command and reporting system of claim 10, wherein the main module further comprises at least one digital output configurable by the user, at least one analog output configurable by the user, or a combination thereof.

15. The command and reporting system of claim 10, wherein the main module further comprises at least one safety signal input for a safety-oriented device.

16. The automation system of claim 11, wherein the main module further comprises at least one safety signal input for a safety-oriented device.

17. The automation system of claim 11, wherein the command is configured to transport a parameter separately to at least one of the at least two command and reporting devices.

18. The automation system of claim 16, wherein the controller has a connection for an exchangeable storage module configured to transmit at least one parameter for the safety-oriented device.

19. The main module of claim 5, wherein the safety-oriented device is an emergency-stop device.
